(19) United States
(12) Patent Application Publication
(10) Pub. No.: US 2005/0160319 A1
(43) Pub. Date: Jul. 21, 2005

(54) System and method for detecting and reporting resource conflicts

(76) Inventors: Scott Bernard Marcak, Cypress, TX (US); Don R. James JR., Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/758,185

(22) Filed: Jan. 14, 2004

(51) Int. Cl. G06F 11/00

(52) U.S. Cl. 714/32

(57) ABSTRACT

A system and method of resource conflict detection and reporting during power on self test is provided. The method includes, for example, reading the state of a flag indicative of a user-selected compatibility mode requiring at least partial reallocation of resources. If the flag is in a first state and one or more devices will become inaccessible due to resource constraints, at least one message indicative of a resource conflict is generated.

### BACKGROUND

Power on self test (POST) is a procedure by which computers ensure that all of their system components are working properly prior to actually loading of the operating system (OS). POST is typically a part of the computer's BIOS (board input/output system), which is responsible for interfacing between the OS and the hardware.

ATA (Advanced Technology Attachment) interfaces are among the most common type of interfaces used to connect mass storage devices to a computer's input/output system. Mass storage devices typically include, for example, diskette, hard disk, CD-ROM, and DVD-ROM drives. Several ATA interface standards have been developed as computer's continue to increase in speed and capacity. Nevertheless, each ATA interface standard defines a particular specification for connecting to mass storage devices.

Of the several forms of ATA interfaces available, a parallel ATA interface (PATA) typically allows up to two mass storage devices to be connected to a computer's ATA host adapter through a parallel connection. Serial ATA (SATA) interfaces have been designed as a replacement for PATA interfaces and allow each mass storage device to be directly connected to the ATA host adapter. However, it is not uncommon for chipset manufacturers to include both PATA and SATA interfaces for versatility and compatibility reasons. Such chipsets include, for example, the Intel® 82801EB ICH5 and Intel® 82801ER ICH5 R (ICH5R) chipsets.

One trend in configuring the SATA and PATA interfaces is to have the BIOS dynamically assign the computer's resources (I/O addresses and interrupts) based on the needs of the system components including the mass storage devices connected to the interfaces. This trend is consistent with the trend in providing an OS that is compatible with such dynamic resource allocation. One such example of dynamic resource allocation is provided by the PnP (Plug and Play) standard. These types of OS and BIOS are compatible because the OS recognizes that the SATA and PATA interfaces will be assigned resources dynamically.

“Legacy software”, as used herein, includes any Operating System (OS) component, device driver, or application that directly manipulates the ATA interface and assumes it may be accessed through well-known, fixed resources rather than checking for dynamically-assigned resources. An issue arises when a legacy OS is used in conjunction with a BIOS that dynamically assigns resources to the ATA interface. In such scenarios, the legacy OS will not be able to properly interface with the mass storage devices or other devices if they are not allocated the range of resources expected by the legacy OS. This prevents the computer from being able to access the affected devices.

### SUMMARY

According to one embodiment, a method of Power On Self Test resource conflict detection and reporting is provided. The method includes, for example, dynamically assigning resources to provide electronic access to devices physically attached to a computer system and reading the state of a flag indicative of a user-selected compatibility mode requiring at least partial reallocation of resources. If the flag is in a first state and one or more devices will become inaccessible due to resource constraints, at least one message indicative of a resource conflict is generated. The method also reallocates at least a portion of the resources according to the user-selected compatibility mode.

### BRIEF DESCRIPTION OF THE DRAWINGS

FIG. 1 is an exemplary overall system diagram in accordance with one embodiment of the present invention; and

FIG. 2 is one embodiment of a flow diagram in accordance with one embodiment of the present invention.

### DETAILED DESCRIPTION OF ILLUSTRATED EMBODIMENTS

The following includes definitions of exemplary terms used throughout the disclosure. Both singular and plural forms of all terms fall within each meaning:

“Software”, as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Logic”, synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

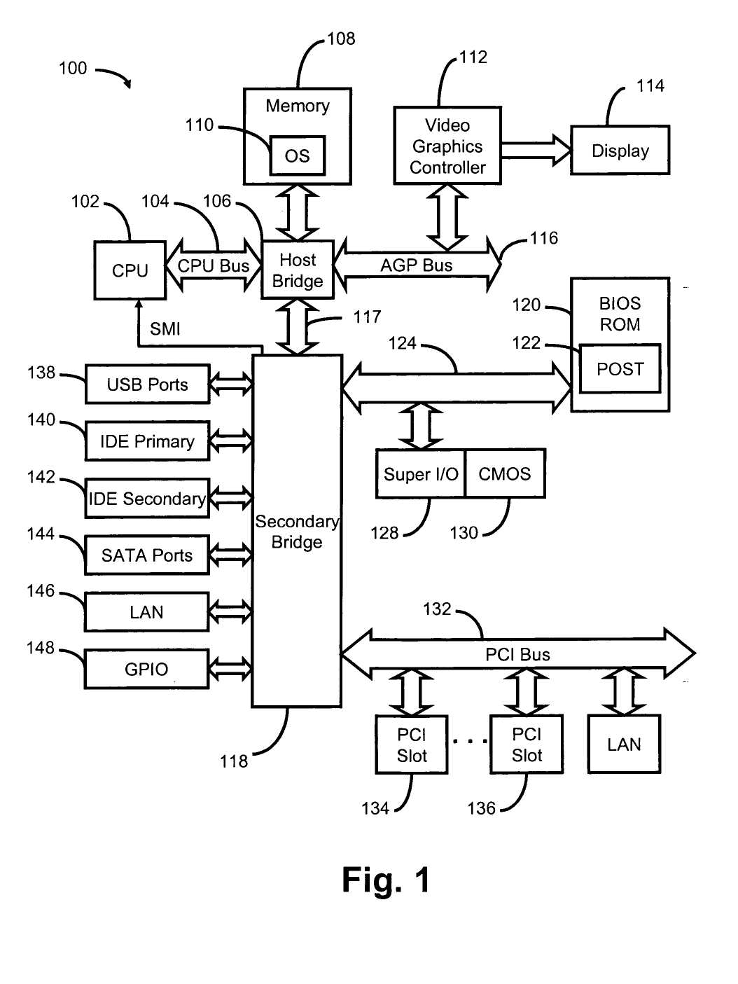

Referring now to FIG. 1, a computer system 100 constructed in accordance with one embodiment generally includes a central processing unit (“CPU”) 102 coupled to a host bridge logic device 106 over a CPU bus 104. CPU 102 may include any processor suitable for a computer such as, for example, a Pentium class processor provided by Intel. A system memory 108, which preferably is one or more synchronous dynamic random access memory (“SDRAM”) devices (or other suitable type of memory device), couples to host bridge 106 via a memory bus. Further, a graphics controller 112, which provides video and graphics signals to a display 210, couples to host bridge 106 by way of a suitable graphics bus, such as the Advanced Graphics Port (“AGP”) bus 116. A display 114 may be a Cathode Ray Tube, liquid crystal display or any other similar visual output device. Host bridge 106 also couples to a secondary bridge 118 via bus 117.

Secondary Bridge 118 is an I/O controller chipset. The secondary bridge 118 interfaces a variety of I/O or peripheral devices to CPU 102 and memory 108 via the host bridge 106. The host bridge 106 permits the CPU 102 to read data from or write data to system memory 108. Further, through host bridge 106, the CPU 102 can communicate with I/O devices connected to the secondary bridge 118 and, and similarly, I/O devices can read data from and write data to system memory 108 via the secondary bridge 118 and host bridge 106. The host bridge 106 preferably has memory controller and arbiter logic (not specifically shown) to provide controlled and efficient access to system memory 108 by the various devices in computer system 100 such as CPU 102 and the various I/O devices. A suitable host bridge is, for example, a Memory Controller Hub such as the Intel® 875P Chipset described in the Intel® 82875P (MCH) Datasheet, which is hereby fully incorporated by reference.

Referring still to FIG. 1, secondary bridge logic device 118 may be an Intel® 82801EB I/O Controller Hub 5 (ICH5)/Intel® 82801ER I/O Controller Hub 5 R (ICH5R) device provided by Intel and described in the Intel® 82801EB ICH5/82801ER ICH5R Datasheet, which is incorporated herein by reference in its entirety. The secondary bridge includes various controller logic for interfacing devices connected to Universal Serial Bus (USB) ports 138, Integrated Drive Electronics (IDE) primary and secondary channels (also known as parallel ATA channels or sub-system) 140 and 142, Serial ATA ports or sub-systems 144, Local Area Network (LAN) connections, and general purpose I/O (GPIO) ports 148. Secondary bridge 118 also includes a bus 124 for interfacing with BIOS ROM 120, super I/O 128, and CMOS non-volatile memory 130. Secondary bridge 118 further has a Peripheral Component Interconnect (PCI) bus 132 for interfacing with various devices connected to PCI slots or ports 134-136. The primary IDE channel 140 can be used, for example, to couple a master hard drive device and a slave CD-ROM device (e.g., mass storage devices) to the computer system 100. Alternatively or in combination, SATA ports 144 can be used to couple such mass storage devices or additional mass storage devices to the computer system 100.

The BIOS ROM 120 includes firmware that is executed by the CPU 102 and which provides low level functions, such as access to the mass storage devices connected to secondary bridge 118. The BIOS firmware also contains the instructions executed by CPU 102 to conduct System Management Interrupt (SMI) handling and Power-On-Self-Test (“POST”) 122. POST 102 is a subset of instructions contained with the BIOS ROM 102. During the boot up process, CPU 102 copies the BIOS to system memory 108 to permit faster access.

The super I/O device 128 provides various inputs and output functions. For example, the super I/O device 128 may include a serial port and a parallel port (both not shown) for connecting peripheral devices that communicate over a serial line or a parallel pathway. Super I/O device 108 preferably also includes a non-volatile memory portion 130 in which various parameters can be stored and retrieved. These parameters may be system and user specified configuration information for the computer system such as, for example, user selections from computer set-up or system configuration information. The memory portion 130 in National Semiconductor's 97338VJG is a complementary metal oxide semiconductor (“CMOS”) memory portion. Memory portion 130, however, can be located elsewhere in the system.

The operation of various components in the computer system shown in FIG. 1 will now be briefly described. The CPU 102 executes user application software and system firmware and software such as the operating system (OS) 110, device drivers and BIOS firmware, which may reside or be loaded into memory 108. The System BIOS firmware 120 contains routines that permit direct interface with hardware (e.g., mass storage devices) connected to the computer system 100. Generally, an application program under control of the operating system makes a request for a resource. The operating system may send the request to the file system or initiate a call to the appropriate device driver corresponding to the bridge that can service the request.

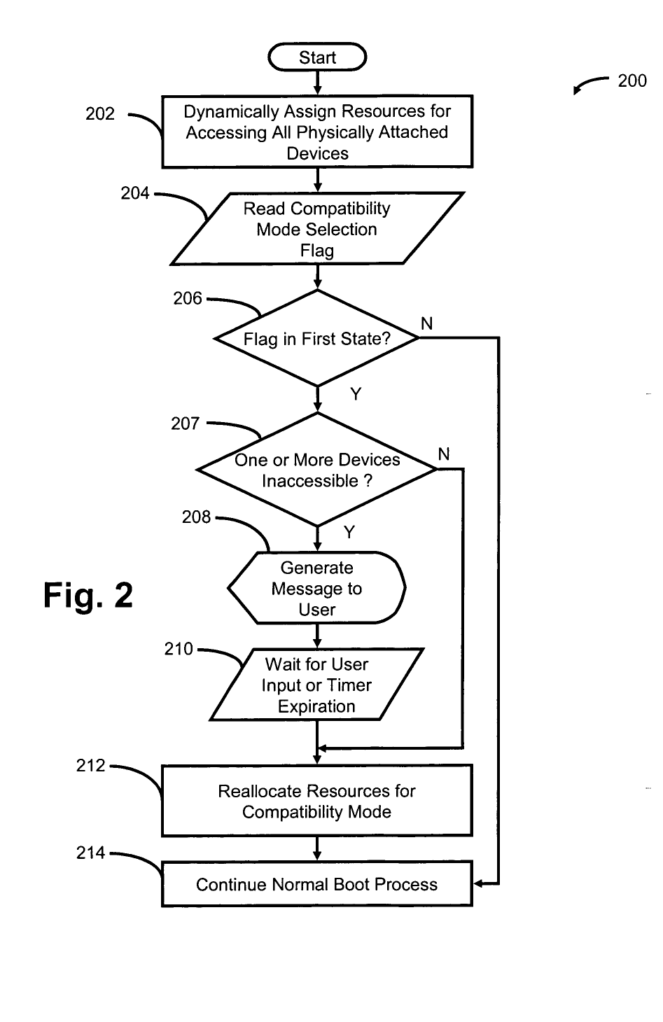

FIG. 2 is one embodiment of a flow diagram 200 showing the processing performed to detect resource conflicts. The rectangular elements denote “processing blocks” and represent computer software instructions or groups of instructions. The diamond shaped elements denote “decision blocks” and represent computer software instructions or groups of instructions which affect the execution of the computer software instructions represented by the processing blocks. Alternatively, the processing and decision blocks represent steps performed by functionally equivalent circuits such as a digital signal processor circuit or an application-specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown.

The flow diagram 200 can be implemented completely within the POST logic 122 or partly therein, with the remainder being implemented within the other portions of the BIOS. The flow begins in block 202 where the resources for accessing all physically attached devices are dynamically allocated based on the requirements of the attached I/O devices (e.g., mass storage devices). The resources define the computer system's available I/O addresses and interrupts that are used to form the communication interface between the CPU 102 and the devices attached to, for example, secondary bridge 118. During POST, the BIOS dynamically assigns these I/O addresses and interrupts to the devices according to any of a plurality of possible standards. Two such standards are the Peripheral Component Interconnect Standard and the Plug and Play Standard.

During such dynamic resource allocation, the BIOS assigns the resources necessary for communicating with one or more parallel ATA sub-systems such as, for example, IDE primary and IDE secondary sub-systems 140 and 142. Also during such dynamic resource allocation, the BIOS assigns the resources necessary for communicating with one or more serial ATA sub-systems 144. Upon completion of this dynamic resource allocation, all devices should be interfaced to the CPU 102. The process of accessing devices using the dynamically assigned resources is sometimes referred to as the native mode of I/O addressing.

In block 204, the flow reads a compatibility mode selection flag from non-volatile memory such as, for example, CMOS 130. The flag indicates whether the user has defined a compatibility mode of operation. The compatibility mode of operation is a user-selectable Computer Set-up option that dictates whether the BIOS assigns fixed, well-known resources to the PATA and SATA subsystems. This compatibility mode can be invoked, for example, when a legacy OS that requires fixed ranges of I/O addresses and interrupts is to be used with a computer system having a BIOS that would normally assign those resources dynamically. The compatibility mode allows a user to force the I/O addresses and interrupts to the ranges expected by the legacy OS. Since there are only a finite number of legacy resources, activating compatibility mode renders devices attached to certain attachment points inaccessible. Precisely which device(s) or location(s) become inaccessible is dependent on the secondary bridge 118 chipset used and, when more than one mapping of ATA devices into the legacy address space is supported by the chipset, the mapping(s) used by the BIOS to implement the compatibility mode Computer Setup option. Hence, by knowing the specified legacy resources required through the read compatibility mode settings and the native resource allocation or mapping(s) completed by the BIOS, the BIOS can determine which devices will become inaccessible by the compatibility mode.

If a user has selected the compatibility mode of operation, the compatibility mode selection flag is set to a first state and stored in non-volatile memory. While this flag can be implemented according to a variety of forms, one implementation can be in the form of the state of a memory bit (logic “1” or “0”). Reading the bit identifies the state of the flag. For example, a first state of the flag could be defined as the logic “1” state of the bit. A second state of the flag could be defined as the logic “0” state of the bit, or vice-versa.

In block 206, the flow tests to determine if the flag is in a state that indicates that the user has selected compatibility mode. If so, the flow advances to block 207 where the compatibility mode settings (e.g., specified legacy resources) are read and the flow tests to determine if one or more devices will be inaccessible by the settings. If the flag is not set, then the flow branches to block 216 and continues the normal boot process.

In block 207, the BIOS can determine which devices will become inaccessible through the compatibility mode settings by knowing the specified legacy resources required and the native resource allocation or mapping(s). If a device has been detected at an attachment point that will become inaccessible in the compatibility mode, the flow advances to block 208 where the it generates and displays a message to the user. If all devices will remain accessible, the flow branches to block 212.

In block 208, the message to the user can include one or more notices such as, for example, a notice that the compatibility mode with the current ATA device topology will cause one or more devices to become inaccessible. Other notices can be included in addition or alternatively such as, for example, a notice to relocate the affected devices to attachment points that will remain accessible in the compatibility mode, a notice to remove the affected devices if they are not needed, or a notice to enter the computer setup and disable compatibility mode if the OS supports accessing IDE controllers in native mode. Other messages can also be displayed.

In block 210, the flow waits for either the user to press a key to continue or for a timer to expire thereby ensuring that the message has been displayed for a period of time. In block 212, the flow allocates legacy resources according to the user-selected compatibility mode settings. This can include reconfiguring at least one parallel AT attachment sub-system such as, for example, IDE primary and secondary sub-systems 140 and 142. This reconfiguration can also include reconfiguring at least one serial AT attachment sub-system such as, for example, SATA ports or sub-systems 144.

In block 214, the flow resumes the normal boot process of the computer system. Block 214 is branched to from block 206 if the compatibility flag is not set to the state indicating that the compatibility mode is to be made active.

The logic flow shown and described herein may reside in or on a computer readable medium or product such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The process flows described herein may be rearranged, consolidated, and/or re-organized in their implementation as warranted or desired so long as the relative order is maintained. For example, other related or unrelated process flows can be interjected between the specified process blocks without affecting the functionality or results obtained.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, the POST logic can be further modified to display the user-selected compatibility mode settings or allow their modification to the extent permitted by the secondary bridge chipset. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A method of Power On Self Test resource conflict detection and reporting comprising the steps of:
dynamically assigning resources to provide electronic access to devices physically attached to a computer system;
reading the state of a flag indicative of a user-selected compatibility mode requiring at least partial reallocation of resources;
if the flag is in a first state and one or more devices will become inaccessible due to the reallocation of resources, generating at least one message indicative of a resource conflict; and
reallocating at least some of the resources according to the user-selected compatibility mode.

2. The method of claim 1 wherein the step of dynamically assigning resources to provide electronic access to devices physically attached to a computer system comprises configuring at least one parallel AT attachment sub-system.

3. The method of claim 1 wherein the step of dynamically assigning resources to provide electronic access to devices physically attached to a computer system comprises configuring at least one serial AT attachment sub-system.

4. The method of claim 1 wherein the step of generating at least one message indicative of a resource conflict comprises generating at least one message indicating that at least one device is inaccessible due to the reallocation of resources required by the user-selected compatibility mode.

5. The method of claim 1 wherein the step of generating at least one message indicative of a resource conflict comprises generating the at least one message for a predetermined period of time.

6. The method of claim 1 wherein reallocating resources according to the user-selected compatibility mode comprises reconfiguring at least one parallel AT attachment sub-system.

7. The method of claim 1 wherein reallocating resources according to the user-selected compatibility mode comprises reconfiguring at least one serial AT attachment sub-system.

8. A software product including one or more computer executable instructions for performing a power on self test, the software product comprising:
first computer executable instructions that cause a computer to dynamically assign resources to provide electronic access to devices physically connected to the computer;
second computer executable instructions that cause a computer to read the state of a flag indicative of a user-selected compatibility mode requiring at least partial reallocation of resources;
third computer executable instructions that generate at least one message indicative of a resource conflict if the flag is in a first state and one or more devices will become inaccessible due to the reallocation of resources; and
fourth computer executable instructions that reallocate at least some resources according to the user-selected compatibility mode.

9. The software product of claim 8 wherein the third computer executable instructions that generate at least one message indicative of a resource conflict comprises instructions that generate at least one message indicating that at least one device is inaccessible due to the reallocation of resources required by the user-selected compatibility mode.

10. The software product of claim 8 wherein the third computer executable instructions that generate at least one message indicative of a resource conflict comprises instructions that generate the at least one message for a predetermined period of time.

11. The software product of claim 8 wherein the fourth computer executable instructions that reallocate at least some resources according to the user-selected compatibility mode comprises instructions that reconfigure at least one parallel AT attachment sub-system.

12. The software product of claim 8 wherein the fourth computer executable instructions that reallocate at least some resources according to the user-selected compatibility mode comprises instructions that reconfigure at least one serial AT attachment sub-system.

13. A computer system comprising:
a CPU,
a memory,
at least one input/output bus,
a board input/output system including logic for performing a power on self test, the power on self test logic comprising instructions that cause the CPU to dynamically assign resources to provide electronic access to devices physically connected to the at least one input/output bus, to read the state of a flag indicative of a user-selected compatibility mode requiring at least partial reallocation of resources, to generate at least one message indicative of a resource conflict if the flag is in a first state and one or more devices will become inaccessible due to the reallocation of resources, and to reallocate at least some resources according to the user-selected compatibility mode.

14. The system of claim 13 wherein the instructions to generate at least one message indicative of a resource conflict comprises instructions that generate at least one message indicating that at least one device is inaccessible due to the reallocation of resources required by the user-selected compatibility mode.

15. The system of claim 13 wherein the instructions to generate at least one message indicative of a resource conflict comprises instructions that generate the at least one message for a predetermined period of time.

16. The system of claim 13 wherein the instructions that reallocate resources according to the user-selected compatibility mode comprises instructions that reconfigure at least one parallel AT attachment sub-system.

17. The system of claim 13 wherein the instructions that reallocate resources according to the user-selected compatibility mode comprises instructions that reconfigure at least one serial AT attachment sub-system.

18. A resource conflict detecting system comprising:
means for dynamically assigning resources to provide electronic access to devices physically attached to a computer system;
means for reading the state of a flag indicative of a user-selected compatibility mode requiring at least partial reallocation of resources;
means for determining if the flag is in a first state and one or more devices will become inaccessible due to the reallocation of resources and generating at least one message indicative of a resource conflict; and
means for reallocating at least some of the resources according to the user-selected compatibility mode.

19. The system of claim 18 further comprising a means for determining if the flag is in a second state and bypassing user resource conflict message generation.

20. The system of claim 18 further comprising means for reading compatibility mode set-up data.
